(19) United States
(12) Patent Application Publication
(10) Pub. No.: US 2012/0275014 A1
(43) Pub. Date: Nov. 1, 2012

(54) TWIST BALL TYPE ELECTRONIC PAPER

(75) Inventors: Kenichi Ogawa, Tokyo-to (JP); Hironori Kobayashi, Tokyo-to (JP); Yoichi Takizawa, Saitama (JP)

(73) Assignees: SOKEN CHEMICAL & ENGINEERING CO., LTD., Tokyo-to (JP); DAI NIPPON PRINTING CO., LTD., Tokyo-to (JP)

(21) Appl. No.: 13/511,510

(22) PCT Filed: Nov. 18, 2010
(86) PCT No.: PCT/JP2010/070588

§ 371 Date: May 23, 2012

(30) Foreign Application Priority Data
Nov. 25, 2009 (JP) 2009-267930

(51) Int. Cl. G02F 1/167

(52) U.S. Cl. 359/296

(57) ABSTRACT

A twist ball type electronic paper having a transparent electrode side base material having a first base material including a film having transparency, and a transparent electrode formed on one side surface of the first base material; a counter electrode side base material having a second base material including a film with an insulation property, and a counter electrode formed on one side surface of the second base material; and a twist ball layer comprising a twist ball and a low polarity solvent layer including a low polarity solvent, wherein the twist ball layer is sealed with the first base material and the second base material, and that the counter electrode side base material is disposed in such a way that the counter electrode is disposed on an opposite side with respect to the twist ball layer.

### TECHNICAL FIELD

The present invention relates to a twist ball type electronic paper with a twist ball used as a display medium.

### BACKGROUND ART

Recently, an information medium called an electronic paper attracts attention. The information medium having the excellent characteristics such as a low electric power consumption property, a bendable flexibility, thinness and a light weight, and in addition, the outstanding characteristic of rewritability is now put into a practical stage. Specifically, its product is being used for transportation advertisements in a train, a display part of a clock, an electronic book, and the like.

There are some kinds of configurations for the information medium. Among them is for example a configuration using a two color phase spherical particle (twist ball) (for example, Patent Literature 1 and Patent Literature 2).

Among the above-described electronic papers using a twist ball, as an electronic paper used for an application of displaying a limited image or pattern such as a poster and a transportation advertisement in a train (hereafter it may be referred to as a segment application), the following configuration has conventionally been proposed. FIG. 8 is a schematic cross-sectional view showing an example of such an electronic paper. As shown in FIG. 8, the electronic paper 100 comprises: a common electrode side base material 101 having a first base material 101a and a common electrode 101b formed on the first base material 101a; a twist ball layer 102 comprising a twist ball 103 and a low polarity solvent and disposed on the first base material 101a on the opposite side with respect to the common electrode 101b side of the common electrode side base material 101; and a display electrode side base material 111 having a second base material 111a and a display electrode 111b formed in a pattern on the second base material and disposed on the twist ball layer 102. Moreover, the display electrode side base material 111 is disposed with the display electrode 111b facing the twist ball layer 102 side with the electronic paper 100 end part sealed with a sealing agent 105.

In the electronic paper 100 shown in FIG. 8, at the time of taking out a wiring 300 from the display electrode 111b, it is necessary to take out the wiring 300 with a through hole provided in the second base material 111a coinciding with the formation position of the display electrode 111b so that a problem arises in that the more minute the pattern of the display electrode 111b is, the more difficult positioning of the display electrode 111b and the through hole of the second base material 111a becomes. Moreover, a step of completely closing the through hole is necessary for sealing the low polarity solvent without liquid leakage, and thus the process is complicated. Furthermore, since the display electrode 111b and the twist ball layer 102 are contacted directly, a problem is involved in that the image display of the electronic paper may be deteriorated due to elusion of the display electrode material into the low polarity solvent of the twist ball layer 102.

Then, electronic papers of configurations shown in FIGS. 9 and 10 are proposed.

The electronic paper 100 shown in FIG. 9 has a configuration with a display electrode 111b formed on a fixed substrate 200 for disposing the same on a second base material 111a via a sealing agent 105, a bonding agent 106, and the like.

Moreover, an electronic paper 100 shown in FIG. 10 has a configuration with a twist ball layer 102, including a low polarity solvent and a twist ball 103, sealed with a film-like first base material 101a and a film-like second base material 111a so that a display electrode 111b formed on a fixed substrate 200 is disposed via a bonding agent 106. Since the numerals not explained in FIGS. 9 and 10 are same as those in FIG. 8, they are not mentioned herein.

According to the above-mentioned configuration, since the twist ball layer 102 including the low polarity solvent and the twist ball 103 is sealed completely with the first base material 101a and the second base material 111a, a step of completely closing the through hole used for connection of the display electrode 111b and the wiring 300 as shown in FIG. 8 is not required. Moreover, since the twist ball layer 102 and the display electrode 111b are not contacted directly according to the above-mentioned configuration, elution of the display electrode material into the low polarity solvent of the twist ball layer 102 can be prevented.

However, according to the electronic papers shown in FIGS. 9 and 10, as in the case of the electronic paper 100 shown in FIG. 8, at the time of taking out the wiring 300 from the display electrode 111b, the wiring 300 needs to be taken out by providing a through hole in the fixed substrate 200 coinciding with the formation position of the display electrode 111b so that a problem arises in that positioning of the display electrode 111b and the through hole of the fixed substrate 200 becomes difficult with a more minute display electrode 111b pattern. Furthermore, in the case the second base material 111a is a flexible film base material, at the time of disposing the display electrode 111b formed on the fixed substrate 200 and the second base material 111a via the bonding agent 106, a problem is involved in that yield of attaching the fixed substrate 200 and the second base material 111a is lowered by the ruggedness of the display electrode 111b and the image display of the electronic paper is deteriorated.

Moreover, since the above-described electronic paper needs a high production cost, reuse thereof is desired.

On the other hand, although it is not shown in drawings, also in a passive drive type electronic paper, comprising: a counter electrode formed like a stripe on a fixed substrate; and a display member further comprising: a transparent electrode side base material having a first base material and a transparent electrode formed on the first base material, a twist ball layer including a twist ball and a low polarity solvent and disposed on the first base material on the opposite side with respect to the transparent electrode side of the transparent electrode side base material, and a second base material disposed on the twist ball layer, in which the counter electrode and the second base material are disposed via a bonding agent, and the like has been proposed. Also in this configuration, a problem is involved in that yield of attaching the fixed substrate and the second base material is lowered by the ruggedness of the counter electrode and the image display of the electronic paper is deteriorated.

### CITATION LIST

### Patent Literature

Patent Literature 1: Japanese Patent Application Publication Laid-Open (JP-A) No. 2006-047614
Patent Literature 2: JP-A No. 2007-206365

### SUMMARY OF INVENTION

### Technical Problem

A main object of the present invention is to provide a twist ball type electronic paper capable of preferably displaying an image and enabling easy-taking out of a wiring. Moreover, another main object of the present invention is to provide a reusable twist ball type electronic paper.

### Solution to Problem

In order to achieve the above-mentioned objects, the present invention provides a twist ball type electronic paper comprising: a transparent electrode side base material having a first base material having a film having transparency, and a transparent electrode formed on one side surface of the above-mentioned first base material; a counter electrode side base material having a second base material including a film with an insulation property, and a counter electrode formed on one side surface of the above-mentioned second base material; and a twist ball layer comprising a twist ball and a low polarity solvent layer including a low polarity solvent, characterized in that the above-mentioned twist ball layer is sealed with the above-mentioned first base material and the above-mentioned second base material, and that the above-mentioned counter electrode side base material is disposed in such a way that the above-mentioned counter electrode is disposed on an opposite side with respect to the above-mentioned twist ball layer.

According to the present invention, since the above-mentioned counter electrode is not contacted directly with the above-mentioned twist ball layer, image display deterioration derived from elution of the counter electrode material into the low polarity solvent can be prevented. Moreover, yield decline at the time of attaching due to ruggedness of the counter electrode or deterioration of the image display of the twist ball type electronic paper can be prevented.

Furthermore, in the case the twist ball type electronic paper of the present invention is an electronic paper used for the segment application (hereafter, it may be referred to as an electronic paper for a segment), since the counter electrode side base material is disposed in such a way that the counter electrode is disposed on the opposite side with respect to the twist ball layer, wiring can easily be taken out.

Moreover, in the present invention, it is preferable that the above-mentioned first base material and the above-mentioned second base material are made of a material enabling a lamination process so that the above-mentioned twist ball layer is sealed by a lamination process of the first base material and the second base material. Since the twist ball layer is sealed by the lamination process of the first base material and the second base material, compared with the case of for example sealing with a sealing agent, and the like, the display area of the twist ball type electronic paper of the present invention can be provided in a wider range. Moreover, since it is a sealing method of a twist ball layer without disposing the sealing agent on the outer periphery of the twist ball layer, in the case of arranging and tiling a plurality of display panels, influence of the joint between the panels to the display can be alleviated. This is because the thermally fused portion of the both film base materials by the lamination process can be disposed on the side surface or the rear surface of the display surface utilizing the plasticity of the film.

Moreover, the present invention provides a twist ball type electronic paper comprising: a twist ball member including: a transparent electrode side base material having a first base material including a film having transparency and a transparent electrode formed on one side surface of the above-mentioned first base material, and a film-like supporting base material with an insulation property, and a twist ball layer including a twist ball and a low polarity solvent layer including a low polarity solvent, in which the above-mentioned twist ball layer is sealed with the above-mentioned first base material and the above-mentioned supporting base material; and a counter electrode side base material having a second base material including a film with an insulation property, and a counter electrode formed on one side surface of the above-mentioned second base material, characterized in that the above-mentioned counter electrode side base material is disposed on an outer side of the supporting base material of the above-mentioned twist ball member in such a way that the above-mentioned counter electrode is on an opposite side with respect to the above-mentioned twist ball member.

According to the present invention, since the above-mentioned counter electrode is not contacted directly with the twist ball layer, image display deterioration derived from elution of the counter electrode material into the low polarity solvent can be prevented. Moreover, yield decline at the time of attaching due to ruggedness of the counter electrode or deterioration of the image display of the electronic paper can be prevented.

Moreover, in the case the twist ball type electronic paper of the present invention is an electronic paper for the segment application, since the counter electrode side base material is disposed on the outer side of the supporting base material of the twist ball member with the counter electrode disposed on the opposite side with respect to the above-mentioned twist ball member, wiring can easily be taken out.

Furthermore, according to the present invention, since the counter electrode side base material is disposed on the outer side of the supporting base material of the twist ball member, the twist ball type electronic paper can easily be reused only by replacing the counter electrode side base material disposed on the twist ball member.

In the present invention, it is preferable that the above-mentioned counter electrode side base material is disposed on a surface on the opposite side with respect to the above-mentioned twist ball member of the above-mentioned supporting base material via a re-detachable adhesive. Since the re-detachable adhesive is used, the above-mentioned counter electrode side base material can easily be replaced.

Moreover, in the present invention, it is preferable that the above-mentioned first base material and the above-mentioned supporting base material are made of a material enabling a lamination process so that the above-mentioned twist ball layer is sealed by a lamination process of the first base material and the supporting base material. Since the twist ball layer is sealed by the lamination process of the first base material and the supporting base material, compared with the case of for example sealing the twist ball layer with a sealing agent, and the like, the display area of the twist ball type electronic paper of the present invention can be provided in a wider range. Moreover, since it is a sealing method of a twist ball layer without disposing the sealing agent on the outer periphery of the twist ball layer, in the case of arranging and tiling a plurality of display panels, influence of the joint between the panels to the display can be alleviated. This is because the thermally fused portion of the both film base materials by the lamination process can be disposed on the side surface or the rear surface of the display surface utilizing the plasticity of the film.

### Advantageous Effects of Invention

Since the twist ball type electronic paper of the present invention has the above-mentioned configurations, the twist ball layer and the counter electrode are not contacted directly, image display deterioration derived from elution of the counter electrode material into the low polarity solvent of the twist ball layer can be prevented. Moreover, yield decline at the time of attaching due to ruggedness of the counter electrode or deterioration of the image display of the electronic paper can be prevented.

Moreover, in the case the twist ball type electronic paper of the present invention is an electronic paper for a segment, since the above-mentioned counter electrode side base material is disposed in such a way that the above-mentioned counter electrode is on the opposite side with respect to the above-mentioned twist ball layer, the wiring of the counter electrode can easily be taken out.

Furthermore, since the twist ball type electronic paper of the present invention has a configuration wherein the counter electrode side base material is disposed on the outer side of the supporting base material of the twist ball member, it can be reused easily only by replacing the counter electrode side base material.

### BRIEF DESCRIPTION OF DRAWINGS

FIGS. 1A and 1B are each a schematic diagram showing an example of a twist ball type electronic paper of the present invention.

FIG. 2 is a schematic cross-sectional view showing another example of a twist ball type electronic paper of the present invention.

FIG. 3 is a schematic diagram showing further another example of a twist ball type electronic paper of the present invention.

FIGS. 4A and 4B are each a schematic cross-sectional view showing an example of a twist ball type electronic paper.

FIG. 5 is a schematic cross-sectional view showing yet another example of a twist ball type electronic paper of the present invention.

FIG. 6 is a schematic cross-sectional view showing still another example of a twist ball type electronic paper of the present invention.

FIG. 7 is a schematic cross-sectional view showing still another example of a twist ball type electronic paper of the present invention.

FIG. 8 is a schematic cross-sectional view showing an example of a twist ball type electronic paper of the present invention.

FIG. 9 is a schematic cross-sectional view showing yet another example of a twist ball type electronic paper of the present invention.

FIG. 10 is a schematic cross-sectional view showing still another example of a twist ball type electronic paper of the present invention.

### DESCRIPTION OF EMBODIMENTS

Hereafter, a twist ball type electronic paper (hereafter, it may be referred to simply as an electronic paper) of the present invention will be explained.

The electronic paper of the present invention can be classified roughly into 2 embodiments according to the position of disposing the counter electrode. Hereafter, an electronic paper of each embodiment will be explained.

### 1. Electronic Paper of a First Embodiment

The electronic paper of the present embodiment comprises: a transparent electrode side base material having a first base material comprising a film having transparency, and a transparent electrode formed on one side surface of the above-mentioned first base material; a counter electrode side base material having a second base material comprising a film with an insulation property, and a counter electrode formed on one side surface of the above-mentioned second base material; and a twist ball layer including a twist ball and a low polarity solvent layer including a low polarity solvent, characterized in that the above-mentioned twist ball layer is sealed with the above-mentioned first base material and the above-mentioned second base material, and that the above-mentioned counter electrode side base material is disposed in such a way that the counter electrode is disposed on an opposite side with respect to the twist ball layer.

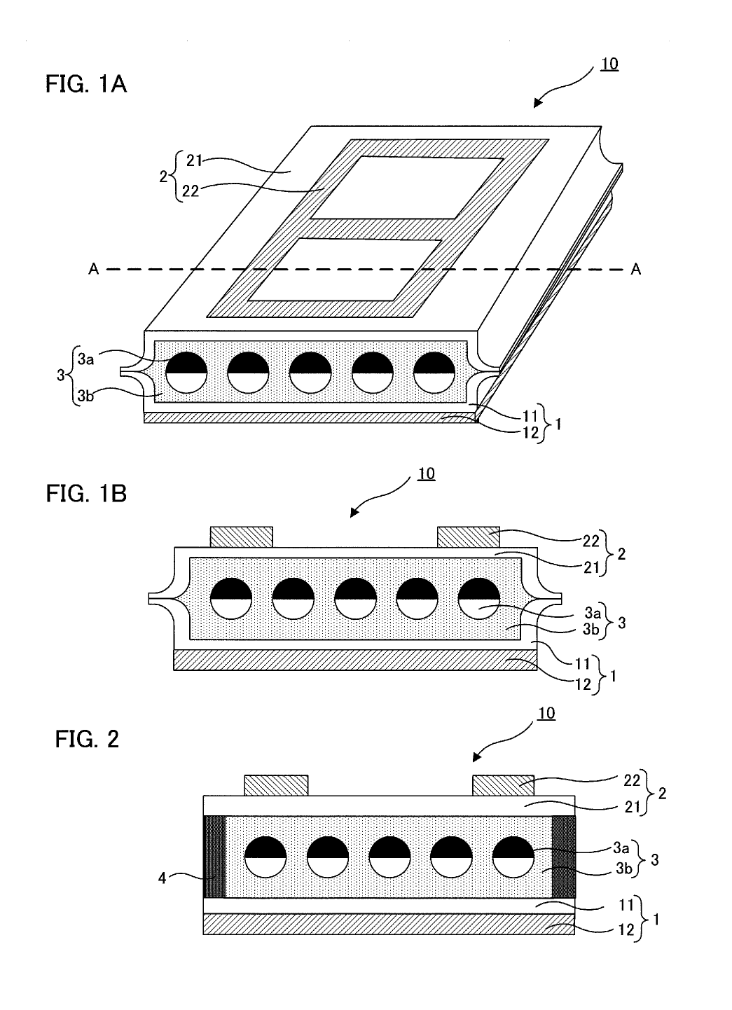

The electronic paper of the present embodiment will be explained with reference to the drawings. FIG. 1A is a schematic diagram showing an example of an electronic paper of the present embodiment, and FIG. 1B is a schematic cross-sectional view taken on the line A-A of FIG. 1A. Here, FIGS. 1A and 1B show the case of the electronic paper of the present embodiment as an electronic paper for a segment. As shown in FIG. 1B, the electronic paper 10 of the present embodiment comprises: a transparent electrode side base material 1 having a first base material 11 comprising a film having transparency, and a transparent electrode 12 formed on one side surface of the first base material; a counter electrode side base material 2 having a second base material 21 comprising a film with an insulation property, and a counter electrode 22 formed on one side surface of the second base material 21; and a twist ball layer 3 comprising a twist ball 3a and a low polarity solvent layer 3b including a low polarity solvent, characterized in that the twist ball layer 3 is sealed with the first base material 11 and the second base material 21, and that the counter electrode side base material 2 is disposed in such a way that the counter electrode 22 is disposed on the opposite side with respect to the twist ball layer 3. As shown in FIGS. 1A and 1B, in the case the electronic paper 10 is an electronic paper for a segment, the counter electrode 22 and the counter electrode side base material 2 are used as a display electrode and a display electrode side base material. Moreover, the transparent electrode 12 and the transparent electrode side base material 1 are used as a common electrode and a common electrode side base material.

Moreover, FIGS. 1A and 1B show an example of sealing the twist ball layer 3 by a lamination process of the first base material 11 and the second base material 21. As shown in FIG. 2, the twist ball layer 3 may be sealed by disposing a sealing agent 4 between the first base material 11 and the second base material 21. Since the numerals not explained in FIG. 2 are same as those of FIGS. 1A and 1B, they are not mentioned here.

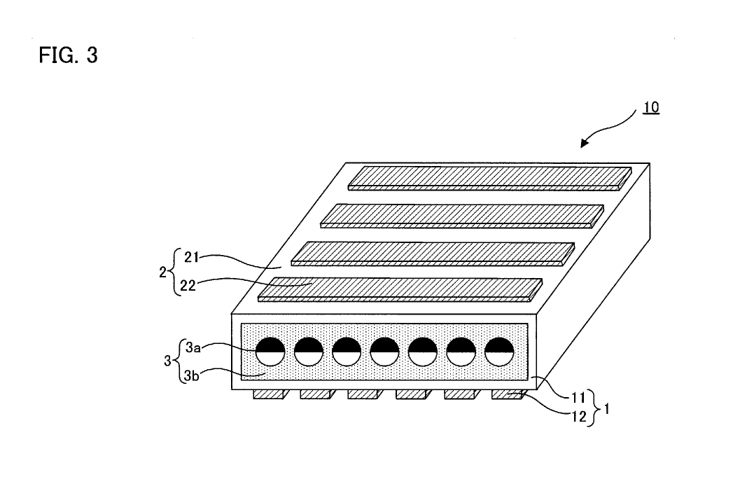

Moreover, FIG. 3 is a schematic diagram showing another example of an electronic paper of the present embodiment. FIG. 3 shows an example of the electronic paper of the present embodiment as a passive driving type electronic paper. As shown in FIG. 3, in the case the electronic paper 10 of the present embodiment is a passive driving type electronic paper, the transparent electrode 12 and the counter electrode 22 are formed on each base material in a stripe-like pattern so as to intersect with each other. In the case the electronic paper 10 is a passive driving type electronic paper as shown in FIG. 3, one of the transparent electrode 12 and counter electrode 22 formed in a stripe-like pattern is used as a scanning (row) electrode and the other as a signal (column) electrode.

Since the numerals not explained in FIG. 3 are same as those of FIGS. 1A and 1B, they are not mentioned here.

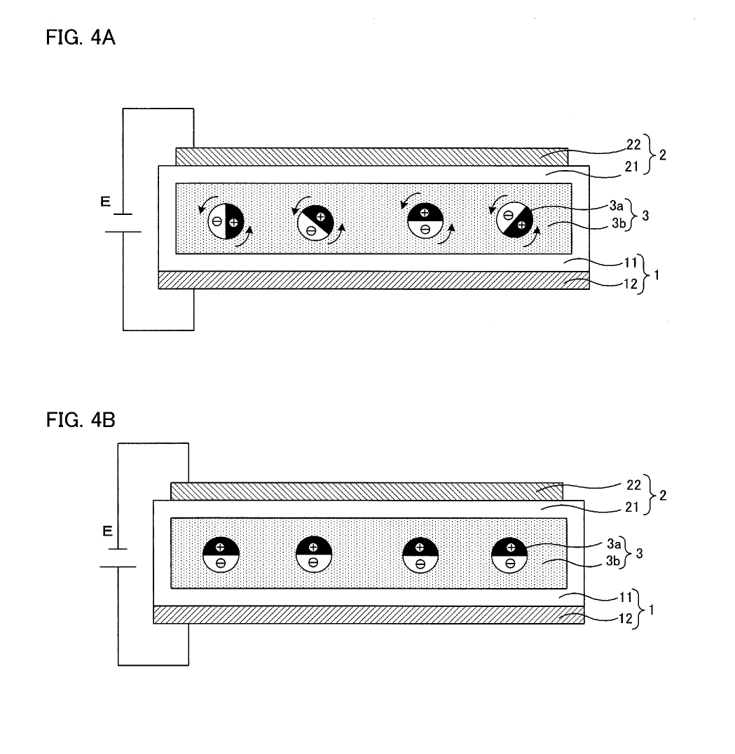

Here, the method of image display using an electronic paper using a twist ball will be explained with reference to an example. FIGS. 4A and 4B are each a schematic cross-sectional view showing an example of an electronic paper. In FIGS. 4A and 4B, the twist ball 3a has a black phase portion charged with a positive charge, and a white phase portion charged with a negative charge so as to form a permanent dipole. Moreover, the first base material 11 has an insulation property. As shown in FIGS. 4A and 4B, by applying a predetermined electric field E between the transparent electrode 12 and the counter electrode 22, the twist ball 3a interposed between the transparent electrode 12 and the counter electrode 22 is in an electric field. As described above, since the twist ball 3a has the black phase charged with a positive charge and the white phase charged with a negative charge, in the above-mentioned application state, each twist ball 3a (FIG. 4A) has the black phase of the twist ball 3a oriented to the second base material 21 side and the white phase of the twist ball 3a oriented to the first base material 11 side (FIG. 4B).

Moreover, although it is not shown in drawings, if an electric field of the opposite direction with respect to the above-described electric field is applied between the transparent electrode 12 and the counter electrode 22, the black phase of the twist ball is oriented to the first base material side, and the white phase of the twist ball is oriented to the second base material side.

In such an electronic paper using a twist ball, image display can be carried out by controlling the orientation of the twist ball.

FIGS. 4A and 4B each shows that the twist ball layer 3 is sealed by a lamination process of the first base material 11 and the second base material 21 in a simplified manner. Moreover, since the numerals not explained in FIGS. 4A and 4B are same as those of FIGS. 1A and 1B, they are not mentioned here.

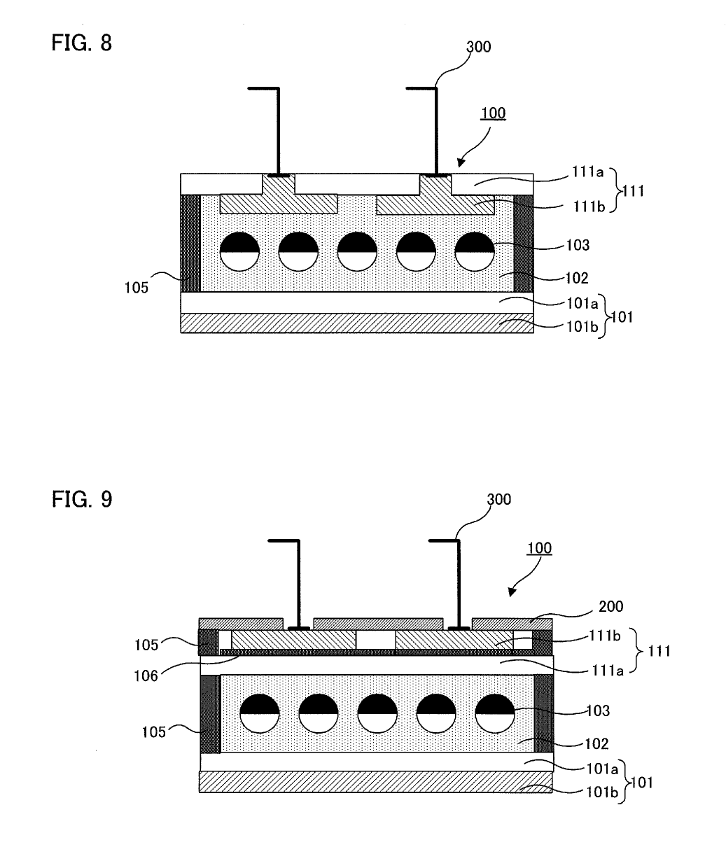

As described above, since the twist ball has a charge, for example as shown in FIG. 8, in the case the electronic paper has a configuration with the twist ball layer 102 and the display electrode 111b contacted directly, the display electrode material having a conductivity eluted into the low polarity solvent of the twist ball layer 102 would influence the twist ball 103 so that a problem is involved in that the display quality of the electronic paper may be lowered. Moreover, at the time of taking out the wiring 300 from the display electrode 111b, the wiring 300 should be taken out by providing a through hole in the second base material 111a according to the formation position of the display electrode 111b so that a problem arises in that positioning of the display electrode 111b and the through hole of the second base material 111a becomes difficult with a finer display electrode 111b pattern. Furthermore, a step of completely closing the through hole is required for sealing the low polarity solvent without liquid leakage so that the step is complicated.

FIG. 8 shows an example of an electronic paper for a segment. Although it is not shown in the drawing, also in a passive driving type electronic paper, in the case of a configuration with the counter electrode and the twist ball layer contacted directly, a problem is involved in that the display quality of the electronic paper may be deteriorated.

On the other hand, according to the present embodiment, since the above-mentioned counter electrode is not contacted directly with the above-mentioned twist ball layer, the counter electrode material is not eluted into the low polarity solvent included in the twist ball layer so that deterioration of the image display of the electronic paper can be restrained.

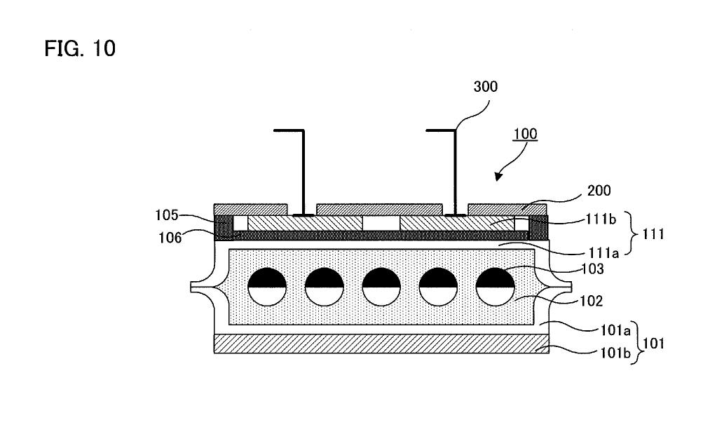

Moreover, as to the configuration with the twist ball layer and the display electrode not contacted directly, as it is shown in FIGS. 9 and 10, a configuration of forming a display electrode 111b on a fixed substrate 200 for disposing the same onto a second base material 111a has also been considered. Also in this case as in FIG. 8, since positioning of the fixed substrate 200 and the display electrode 111b is required for providing the through hole in the fixed substrate 200 for taking out the wiring 300 from the display electrode 111b, a problem is involved in that the production step of the electronic paper is complicated. Furthermore, in the case the second base material 111a is a plastic film base material, at the time of disposing the display electrode 111b formed on the fixed substrate 200 and the second base material 111a via the bonding agent 106, a problem arises in that yield in attaching the fixed substrate 200 and the second base material 111a is lowered due to ruggedness of the display electrode 111b and the image display of the electronic paper is deteriorated.

FIGS. 9 and 10 show an example of an electronic paper for a segment. Although it is not shown in drawings, also in the case of a passive driving type electronic paper, yield decline at the time of production of the electronic paper due to ruggedness of the counter electrode and image display deterioration of the electronic paper are problematic.

On the other hand, according to the present embodiment, since the counter electrode is disposed on the opposite side with respect to the twist ball layer, yield decline at the time of attaching due to ruggedness of the counter electrode and image display deterioration of the electronic paper can be prevented.

Furthermore, in the case the electronic paper of the present embodiment is an electronic paper for a segment, since the counter electrode is disposed on the opposite side with respect to the twist ball layer, the wiring of the counter electrode can easily be taken out.

Hereafter, each configuration of the electronic paper of the present embodiment will be explained.

### (1) Counter Electrode Side Base Material

The counter electrode side base material used in the present embodiment has a second base material including a film with an insulation property, and a counter electrode formed on one side surface of the above-mentioned second base material. The counter electrode side base material is used in such a way that the counter electrode is disposed on the opposite side with respect to the twist ball layer to be described later.

In the present embodiment, in the case the electronic paper of the present embodiment is an electronic paper for a segment, the above-mentioned counter electrode side base material is used as a display electrode side base material.

Hereafter, the counter electrode, and the second base material used for the counter electrode side base material will be explained, respectively.

### (a) Counter Electrode

The counter electrode used in the present embodiment is formed on the second base material to be described later.

Here, in the case the electronic paper of the present embodiment is an electronic paper for a segment, the above-mentioned counter electrode is used as a display electrode. Moreover, in the case the electronic paper of the present embodiment is a passive driving type electronic paper, either of the above-mentioned counter electrode and the transparent electrode to be described later is used as a scanning (row) electrode and the other as a signal (column) electrode.

The above-mentioned counter electrode is not particularly limited as long as it is made of a material with a conductivity so that image display is enabled using the twist ball layer to be described later by applying a voltage to the counter electrode. As such a counter electrode, the counter electrode may be: formed directly on the second base material; formed between the second base material and the counter electrode via an adhesive layer, and the like; or formed by forming the counter electrode on a film other than the second base material, and disposing the film with the counter electrode formed on the second base material. In the present embodiment, for simplifying the step, it is more preferable that the counter electrode is formed directly on the second base material.

Moreover, the shape of the counter electrode used in the present embodiment is not particularly limited as long as it has a shape according to the design to be displayed in the case the electronic paper of the present embodiment is an electronic paper for a segment. As a specific design, for example, characters and patterns can be presented.

Moreover, in the case the electronic paper of the present embodiment is a passive driving type electronic paper, as shown in FIG. 3, the above-mentioned counter electrode has a pattern corresponding to the pattern of the transparent electrode to be described later. Since the pattern of the counter electrode may be same as the pattern of the counter electrode used for a common passive driving type display device, it is not mentioned here.

The material used for such a counter electrode is not particularly limited as long as it has conductivity. Examples thereof include a product prepared by blending a metal such as Au, Al, Ag, Ni, and Cu, a transparent conductor such as ITO, SnO₂, and ZnO:Al, or a conductive agent in a solvent or a synthetic resin binder. As examples of the above-mentioned conductive agent, cationic polymer electrolytes such as polymethyl benzyl trimethyl chloride, and polyallyl polymethyl ammonium chloride, anionic polymer electrolytes such as polystyrene sulfonate, and polyacrylate, electron conductive zinc oxide, tin oxide, indium oxide, carbon fine powders, and Ag fine powders can be used.

In the present embodiment, as the material used for the counter electrode, in particular, in consideration of the conductivity and formation on the film base material, a flexible conductive material capable of enduring the stretch of the base material, such as a conductive paste prepared by blending a metal such as Au, Cu, Al, and Ag, carbon, Ag fine powders, and the like in a synthetic resin binder is preferable.

As the forming method for the counter electrode, in the case of forming the counter electrode directly on the second base material to be described later, a method of forming a thin film in a pattern on the second base material using the above-described metal, transparent conductor, and the like with a metal mask, and the like, by a sputtering process, a vacuum deposition process, a CVD process, an application method and the like, and a method of blending the conductive agent with a solvent or a synthetic resin binder for applying the same on the second base material in a pattern can be presented for example.

On the other hand, in the case of forming the counter electrode on the second base material to be described later via an adhesive, and the like, and a method of cutting out a metal foil made of the above-mentioned metal into a predetermined shape and attaching the same onto the second base material by an adhesive can be presented for example.

Moreover, in the case of disposing the counter electrode on the second base material via a film other than the second base material, a method of forming the counter electrode on the above-mentioned film in a pattern, and disposing the same on the second base material via an adhesive, and the like, and a method of cutting out a film with the above-described metal, transparent conductor, and the like deposited on the entire surface into a predetermined shape, and attaching the same onto the second base material with an adhesive, and the like can be presented. The above-mentioned film to have the counter electrode formed may be made of the same material as that of the second base material. Moreover, as the above-mentioned adhesive, and the like, those used at the time of attaching an electrode onto a resin base material in a common electrode member can be used, and thus it is not mentioned here.

The film thickness of the counter electrode is not particularly limited as long as it is formed on the surface on the opposite side with respect to the twist ball layer side of the second base material to be described later by an even film thickness, and it has a film thickness to the extent that image display can be carried out with the electronic paper of the present embodiment. Specifically, it is preferably in a range of 50 nm to 500 μm, more preferably in a range of 100 nm to 100 μm, and particularly preferably in a range of 300 nm to 50 μm. In the case the counter electrode film thickness is less than the above-mentioned range, the counter electrode can hardly be formed by an even film thickness. In the case the film thickness of the counter electrode is more than the above-mentioned range, formation of the counter electrode takes time, and moreover, the material of the counter electrode is required by a large quantity so that the production cost is made higher.

### (b) Second Base Material

The second base material used in the present embodiment comprises a film having an insulation property with the above-mentioned counter electrode formed on one side surface of the second base material. Moreover, it is for sealing the twist ball layer to be described later together with the first base material used for the transparent electrode side base material to be described later.

The second base material used in the present embodiment is not particularly limited as long as it has a self supporting property to the extent that the counter electrode can be formed on the second base material. Moreover, the second base material may either be transparent or not transparent, but those having no transparency are preferable. The electronic paper of the present embodiment has image display observed from the transparent electrode side. Therefore, in the present embodiment, in the case of observing the electronic paper from the transparent electrode side, since the second base material is disposed on the lower layer side of the twist ball layer for carrying out the image display, in the case the second base material is transparent, problems such as light leakage may be generated.

Moreover, in the present embodiment, as needed, the second base material may be colored to the color of one of the twist balls used for the image display.

The material for such a second base material is not particularly limited as long as it is a common plastic material. Examples thereof include polypropylene, polyethylene, polyvinyl chloride, polystyrene, polyvinyl alcohol, polyimide, polyethylene naphthalate, polyethylene terephthalate, polycarbonate, polyether imide, polyether ether ketone, polyether ketone, polyphenylene sulfide, liquid crystal polymer, an epoxy resin, a silicone resin and a phenol resin.

Moreover, in the present embodiment, the twist ball layer is sealed preferably by a lamination process of the first base material to be described later and the second base material. In the case of using the lamination process, it is more preferable to use as the second base material a base material with a base film material enabling lamination process and the sealant film material to be described later laminated.

Among the materials for the above-described second base material, as a base film material enabling lamination process, from the viewpoint of the heat resistance by heat pressing at the time of the lamination process, polyimide, polyethylene naphthalate, polyethylene terephthalate, polycarbonate, polyether imide, polyether ether ketone, polyether ketone, polyphenylene sulfide, liquid crystal polymer, an epoxy resin, a silicone resin, and a phenol resin can be presented for example.

Moreover, examples of the sealant film material include non-drawn polypropylene film and two-axis drawn polypropylene film. Moreover, a coating film of a material with a heat sealable property such as polyurethane, polyacrylic, an epoxy resin and a silicone can also be used.

Here, at the time of the lamination process, naturally, the first base material and the second base material are bonded with the sealant film material side faced out of the laminated base film material and sealant film material.

Moreover, in the case of the lamination process using the above-mentioned second base material and the first base material to be described later with the base film material enabling the lamination process and the sealant film material laminated, it is further preferable that the materials of the above-mentioned second base material and the first base material to be described later are the same base film material and sealant film material. Since the materials of the above-mentioned second base material and the first base material to be described later are the same base film material and sealant film material, adhesion of the second base material and the first base material can be improved at the time of the lamination process.

The film thickness of the second base material is not particularly limited as long as it has a film thickness to the extent that the counter electrode can be formed. It is in a range of 10 μm to 300 μm, it is more preferably in a range of 15 μm to 100 μm, and it is particularly preferably in a range of 25 μm to 50 μm. In the case the film thickness of the second base material is less than the above-mentioned range, the counter electrode can hardly be formed on the second base material. In the case the film thickness of the second base material is more than the above-mentioned range, at the time of carrying out display using the electronic paper of the present embodiment, due to the thickness of the second base material, image display may not be carried out using the twist ball. Moreover, due to the thickness of the second base material, the flexibility of the electronic paper of the present embodiment may be lowered.

### (2) Transparent Electrode Side Base Material

The transparent electrode side base material used in the present embodiment has a first base material comprising a film having transparency, and a transparent electrode formed on one side surface of the first base material.

In the present embodiment, in the case the electronic paper of the present embodiment is an electronic paper for a segment, the transparent electrode side base material is used as the common electrode side base material.

Hereafter, the first base material used for the transparent electrode side base material, and the transparent electrode will be explained.

### (a) First Base Material

The first base material used in the present embodiment comprises a film having transparency with the transparent electrode to be described later formed on one side surface of the first base material. Moreover, this is for sealing the twist ball layer to be described later together with the second base material used for the above-described counter electrode side base material.

The first base material used in the present embodiment is not particularly limited as long as it is a film having transparency enabling the transparent electrode to be described later formed on the surface of the first base material so that it may or may not have an insulation property, however, it is preferable that it has an insulation property.

Since the above-mentioned first base material has an insulation property, image display can be carried out preferably by the twist ball in the twist ball layer in the electronic paper of the present embodiment.

Moreover, the material for the first base material is not particularly limited as long as it is a plastic material having transparency. Specifically, since the materials same as those explained for the above-described second base material can be used, they are not mentioned here.

In the present embodiment, since the twist ball layer is sealed preferably by lamination process of the first base material and the second base material, it is more preferable to use a material enabling lamination process for the material of the first base material. Also as to the material enabling the lamination process, since the materials enabling the lamination process same as those explained for the above-described second base material can be used, they are not mentioned here.

The film thickness of such a first base material is not particularly limited as long as it has a self supporting property to the extent that the transparent electrode to be described later can be formed. The film thickness of such a first base material is in a range of 10 μm to 300 μm, it is more preferably in a range of 15 μm to 100 μm, and it is particularly preferably in a range of 25 μm to 50 μm. In the case the film thickness of the first base material is less than the above-mentioned range, the transparent electrode to be described later can hardly be formed on the first base material surface. In the case the film thickness of the first base material is more than the above-mentioned range, due to the thickness of the first base material, image display cannot be carried out so that the flexibility of the electronic paper of the present embodiment may be lowered.

### (b) Transparent Electrode

The transparent electrode used in the present embodiment is formed on the above-mentioned first base material. Here, in the case the electronic paper of the present embodiment is an electronic paper for a segment, the transparent electrode is used as the common electrode. Moreover, in the case the electronic paper of the present embodiment is a passive driving type electronic paper, either of the above-described counter electrode and transparent electrode is used as a scanning (row) electrode and the other as a signal (column) electrode.

The transparent electrode is not particularly limited as long as it is formed on the first base material. For example, the transparent electrode may be formed directly on the first base material, or the transparent electrode may be formed on a film having transparency so that the film having transparency and with the transparent electrode formed is disposed on the first base material.

As the material for such a transparent electrode, a transparent conductor such as ITO, SnO₂, and ZnO:Al can be presented.

In the case the transparent electrode is a common electrode, in general, the transparent electrode is formed on the above-described first base material entire surface.

On the other hand, in the case the transparent electrode is an electrode used for a passive driving type electronic paper, it is formed so as to have a pattern corresponding to the pattern of the above-described counter electrode. Since the pattern of the transparent electrode may be same as the pattern of the transparent electrode used for a common passive driving type display device, it is not mentioned here.

The forming method for the transparent electrode is not particularly limited as long as the transparent electrode can be formed on the first base material by a desired film thickness.

As the method for forming such a transparent electrode, in the case of forming the transparent electrode directly on the first base material, a method of forming a thin film on the first base material using the above-described transparent conductor by a sputtering process, a vacuum deposition process, a CVD process, an application method, and the like can be presented.

Moreover, in the case of forming the transparent electrode on a film having transparency and disposing the film having transparency and with the transparent electrode formed onto the first base material, a method of forming the transparent electrode onto the film having transparency and attaching the same onto the first base material using an adhesive, and the like in the same method as in the case of directly forming the transparent electrode on the first base material, and a method of applying a lamination process to the film having transparency with the transparent electrode formed and the first base material can be presented for example. As the film having transparency, specifically, the same materials as the first base material can be used. Moreover, since the adhesive having transparency, and the like may be same as those used for attaching common resin base materials, and thus it is not mentioned here.

The film thickness of the transparent electrode used in the present embodiment is not particularly limited as long as it is a film thickness capable of being formed on the first base material. The film thickness of the transparent electrode is preferably in a range of 50 nm to 10 μm, more preferably in a range of 100 nm to 5 μm, and particularly preferably in a range of 200 nm to 1 μm. In the case the transparent electrode film thickness is less than the above-mentioned range, the transparent electrode can hardly be formed by an even film thickness on the first base material surface. Moreover, in the case the film thickness of the transparent electrode is more than the above-mentioned range, due to increase of the time and the material used for film formation of the transparent electrode, the production cost is made higher.

### (c) Transparent Electrode Side Base Material

The arrangement of the transparent electrode side base material used in the present embodiment is not particularly limited as long as a desired display can be carried out using the electronic paper of the present embodiment. For example, in the electronic paper of the present embodiment, the transparent electrode side base material may be disposed in such a way that the transparent electrode is on the side of the twist ball layer to be described later, or the transparent electrode side base material may be disposed in such a way that the transparent electrode is on the opposite side with respect to the twist ball layer. In the electronic paper of the present embodiment, it is further preferable that the transparent electrode side base material is disposed in such a way that the transparent electrode is on the opposite side with respect to the twist ball layer. According to the arrangement, since the transparent electrode is not contacted directly with the twist ball layer, the transparent electrode material is not eluded into the low polarity solvent of the twist ball layer so that display quality decline of the electronic paper of the present embodiment can be prevented.

Moreover, in the case a material hardly eluded to the low polarity solvent is used as the material for the transparent electrode, the transparent electrode side base material may be disposed with the transparent electrode disposed on the twist ball layer side to be described later.

In the case the electronic paper of the present embodiment is a passive driving type electronic paper, it is preferable that the transparent electrode side base material is disposed in such a way that the transparent electrode is on the opposite side with respect to the twist ball layer. Since the transparent electrode is formed in a pattern such as a stripe in the passive driving type electronic paper, in the case the transparent electrode is disposed on the opposite side with respect to the twist ball layer, the image display deterioration of the electronic paper due to ruggedness of the transparent electrode can be prevented, and furthermore, wiring can be linked easily without the need of providing a through hole in the transparent electrode side base material.

### (3) Twist Ball Layer

The twist ball layer used in the present embodiment comprises a twist ball and a low polarity solvent layer including a low polarity solvent. It is sealed with the first base material used for the above-mentioned transparent electrode side base material and the second base material used for the above-mentioned counter electrode side base material.

Moreover, the sealing method for the twist ball layer used in the present embodiment is not particularly limited as long as it is sealed with the first base material and the second base material. It may be for example, a method of sealing the twist ball layer by disposing a sealing agent for sealing between the first base material and the second base material, or a method of sealing the twist ball layer by using a material enabling lamination process for the first base material of the transparent electrode side base material and the second base material of the counter electrode side base material, and executing the lamination process of the first base material and the second base material. In the present embodiment, a method of sealing the twist ball layer by the lamination process is more preferable.

The above-mentioned method of sealing the twist ball layer by the lamination process enables a wider range of a display area of the electronic paper compared with the method of using a sealing agent. In the case of arranging and tiling a plurality of display panels, influence of the joint between the panels to the display can be alleviated. This is because the thermally fused portion of the both film base materials by the lamination process may be disposed on the side surface or the rear surface of the display surface utilizing the plasticity of the film.

Moreover, in the case the twist ball layer is sealed with a sealing agent, since the transparent electrode side base material and the counter electrode side base material each have flexibility, a problem is involved in that liquid leakage of the low polarity solvent in the twist ball layer may be generated by exfoliation of a part of the sealing agent, for example.

On the other hand, in the case the twist ball layer is sealed by the lamination process, handling of the twist ball layer laminated with the first base material and the second base material is facilitated.

Since the method for sealing the twist ball layer by the lamination process may be same as a common lamination process, explanation is omitted here.

Moreover, as to the sealing method using a sealing agent, it may be same as a common sealing method of attaching base materials, it is not mentioned here.

The twist ball layer used in the present embodiment is not particularly limited as long as it comprises a twist ball and a low polarity solvent layer including a low polarity solvent so as to be sealed with the above-described first base material and second base material for enabling a desired image display in the electronic paper of the present embodiment. Hereafter, the twist ball, and the low polarity solvent layer used in such a twist ball layer will be explained, respectively.

### (a) Twist Ball

The twist ball used in this the present embodiment is included in the twist ball layer so as to function as a display medium in the electronic paper of the present embodiment.

The twist ball used in the present embodiment is not particularly limited as long as it is spherical and it has two different color phases of a colored phase/a white phase or a colored phase/a colored phase so that the different two color phases have different dipoles, respectively.

Such a twist ball may be same as the twist ball produced by a micro channel production method proposed in JP-A No. 2004-197083.

Here, the micro channel production method is a production method for a twist ball as a two color phase spherical polymer particle and a dipolar spherical particle having a (±) polarity in terms of the charge by using a colored continuous layer and a spherical particle phase with a relationship of an O/W type or a W/O type for successively ejecting the two color colored continuous phases into the spherical particle phase of a flowable medium flowing from the first micro channel for transferring the colored continuous phase to the second micro channel.

In the above-mentioned micro channel production method, in a oil-based or water-based flowable medium containing a polymerizable resin component, a polymerizable resin component in a colored continuous phase with the phase separated into two colors containing a colored dye pigment insoluble to the medium is formed with a polymerizable monomer charged positively and negatively, which are different with each other, for being transferred to a first micro channel, and then the colored continuous phase is ejected successively into a water-based or oil-based spherical particle phase flowing in a second micro channel continuously or intermittently. Then, since the ejected product ejected into the spherical particle phase is formed spherical successively into the particle phase while being ejected, dispersed and transferred in series in the micro channel, a twist ball is prepared optionally by polymerization hardening of the polymerizable resin component in the spherical particle by UV irradiation and/or heating.

As the above-mentioned colored continuous phase, a continuous color phase separated into two color phases, such as separated color phases of two colors selected from any “colored phase/white phase” including for example the group of black/white, red/white, yellow/white, blue/white, green/white, and purple/white, and separated color phases of different two colors of colored phase/colored phase can be presented. The coloring agent for forming such a color phase is not particularly limited as long as it is insoluble to or dispersed uniformly in the flowable dispersion medium containing the polymerizable resin component to be described later so that it may be selected and used optionally. As the above-mentioned coloring agent, a dye and a pigment can be used.

As such a dye and a pigment, those mentioned in JP-A No. 2004-197083 can be used and it is not mentioned here.

The addition amount of the dye and pigment as the coloring agent is not particularly limited. Moreover, since the desired color tone differs depending on factors such as the application of the colored particle. Furthermore, in terms of the dispersion property, and the like in the above-described colored continuous phase, in the present embodiment, it may be added optionally and preferably in a range of 0.1 part by weight to 80 parts by weight, and preferably in a range of 2 parts by weight to 10 parts by weight with respect to 100 parts by weight of the total polymerizable resin component as the polymerizable hardening component in the colored continuous phase.

As the polyerizable resin component (or the polymerizable monomer) used in the twist ball, depending on the kind of the functional group or the substituent of the polymerizable monomer used for the twist ball, the monomer species with the charge property of the twist ball each with the tendency of showing a (−) charge property and a (+) charge property can be presented. Therefore, in the case of using as the polymerizable resin component of the present embodiment at least two or more kinds of monomers, while knowing well the tendency of showing the (+) and (−) tendency thereof, preferably while combining a plurality of monomers with the tendency of the same kind of charge property may be used optionally and preferably.

On the other hand, in the polymerizable resin component (or polymerizable monomer) having in a molecule at least one kind of a functional group and/or a substituent, as the functional group or the substituent, for example, carbonyl group, vinyl group, phenyl group, amino group, amide group, imide group, hydroxyl group, halogen group, sulfonic acid group, epoxy group, and urethane bond can be presented. In the present embodiment, monomer species having a functional group or a substituent in such a polymerizable monomer may be used alone or as a combination of two or more kinds optionally and preferably.

As the polymerizable monomer of the tendency of the (−) charge property and the polymerizable monomer of the tendency of the (+) charge property, since those mentioned in JP-A No. 2004-197083 can be used, it is not mentioned here.

In the present embodiment, in the case such a polymerizable monomer is used in combination with another co-polymerizable monomer at the time of polymerization of the polymerizable resin component after ejection as a colored continuous phase in the second micro channel already described above, although it depends also on the charge property (or electrophoresis property) desired for the colored resin fine particle, if it is a co-polymerized particle with a polymerizable monomer having the monomer of the charge property tendency in the total monomer based on the weight preferably in a range of 1% to 100%, more preferably in a range of 5% to 100%, and particularly preferably in a range of 10% to 100%, it may be used optionally and preferably for providing a desired twist ball.

Moreover, the twist ball may be prepared optionally as a spherical single dispersion particle with the average particle size based on the volume in a range of 1.0 μm to 400 μm, preferably in a range of 20 μm to 200 μm and further preferably in a range of 50 μm to 120 μm. Moreover, a uniform particle with an extremely low irregularity of its average particle size can be prepared optionally. In the present embodiment, with the uniformity ratio thereof represented by the Cv value, a twist ball of a single dispersion particle of 20% or less, preferably of 5% or less, and further preferably of 3% or less can be used optionally and preferably.

### (b) Low Polarity Solvent Layer

The low polarity solvent layer used in this embodiment is not particularly limited as long as it includes a low polarity solvent. The low polarity solvent layer in general includes a low polarity solvent, and an elastomer sheet made of an elastomer material for swelling the low polarity solvent.

Hereafter, the low polarity solvent and the elastomer sheet used for the low polarity solvent layer will be explained, respectively.

### (i) Low Polarity Solvent

The low polarity solvent used in this embodiment is used for smooth rotation of the above-described twist ball. Moreover, it is used in general while being swelled in the elastomer sheet to be described later.

The low polarity solvent is not particularly limited as long as it enables smooth rotation of the twist ball without hindering rotation thereof. As such a low polarity solvent, dimethyl silicone oil, isoparaffin-based solvent, straight chain paraffin-based solvent, and straight chain alkane such as dodecane and tridecane can be presented.

### (ii) Elastomer Sheet

The elastomer sheet used in this embodiment is made of an elastomer material capable of swelling the above-mentioned low polarity solvent. Moreover, the elastomer sheet is a sheet-like member with the above-mentioned twist ball dispersed to be used while swelling the low polarity solvent thereby.

The material used for the elastomer sheet is not particularly limited as long as it can disperse the twist ball and it can swell the low polarity solvent.

As the material for the elastomer sheet, a silicone resin, an (slightly cross-linked) acrylic resin, a (slightly cross-linked) styrene resin, and a polyolefin resin can be presented as examples.

Moreover, the thickness of the elastomer sheet is not particularly limited as long as the electronic paper of the present embodiment can carryout the image display by the twist ball dispersed in the elastomer sheet. It is preferably in a range of 50 μm to 1,000 μm, more preferably in a range of 100 μm to 700 μm, and particularly preferably in a range of 200 μm to 500 μm. In the case the film thickness of the elastomer sheet is less than the above-mentioned range, the elastomer sheet with the twist ball dispersed homogeneously can hardly be provided. In the case the film thickness of the elastomer sheet is more than the above-mentioned range, twist ball rotation may be hindered.

### (c) Twist Ball Layer

The film thickness of the twist ball layer used in the present embodiment is not particularly limited as long as the image display is carried out by rotating the twist ball in the electronic paper of the present embodiment. It is preferably in a range of 50 μm to 1,000 μm, more preferably in a range of 100 μm to 700 μm, and particularly preferably in a range of 200 μm to 500 μm. In the case the film thickness of the twist ball layer is less than the above-mentioned range, due to the small distance between the twist ball and the base materials, the twist ball may hardly be rotated to a desired direction. In the case the film thickness of the twist ball layer is more than the above-mentioned range, even in the case an electric field is applied between the above-mentioned transparent electrode and counter electrode, due to the too large distance between the twist ball and the base materials, the image display can hardly be executed using the twist ball in the electronic paper of the present embodiment.

### (4) Other Members

The electronic paper of the present embodiment is not particularly limited as long as it comprises the above-described counter electrode side base material, twist all layer and transparent electrode side base material so that members needed can be added optionally.

As such a member, a sealing agent used for sealing the twist ball layer can be presented. Since such a sealing agent may be same as a common sealing agent used at the time of attaching and sealing base materials, it is not mentioned here.

### (5) Application

The application of the electronic paper of the present embodiment includes a display for a digital appliance, an electronic book, and a digital signage (electronic sign).

### 2. Electronic Paper of a Second Embodiment

The electronic paper of the present embodiment comprises: a twist ball member including: a transparent electrode side base material having a first base material comprising a film having transparency and a transparent electrode formed on one side surface of the above-mentioned first base material, and a film-like supporting base material with an insulation property, and a twist ball layer having a twist ball and a low polarity solvent layer including a low polarity solvent, in which the above-mentioned twist ball layer is sealed with the above-mentioned first base material and the above-mentioned supporting base material; and a counter electrode side base material having a second base material including a film with an insulation property, and a counter electrode formed on one side surface of the above-mentioned second base material, characterized in that the above-mentioned counter electrode side base material is disposed on the outer side of the supporting base material of the above-mentioned twist ball member in such a way that the above-mentioned counter electrode is on the opposite side with respect to the above-mentioned twist ball member.

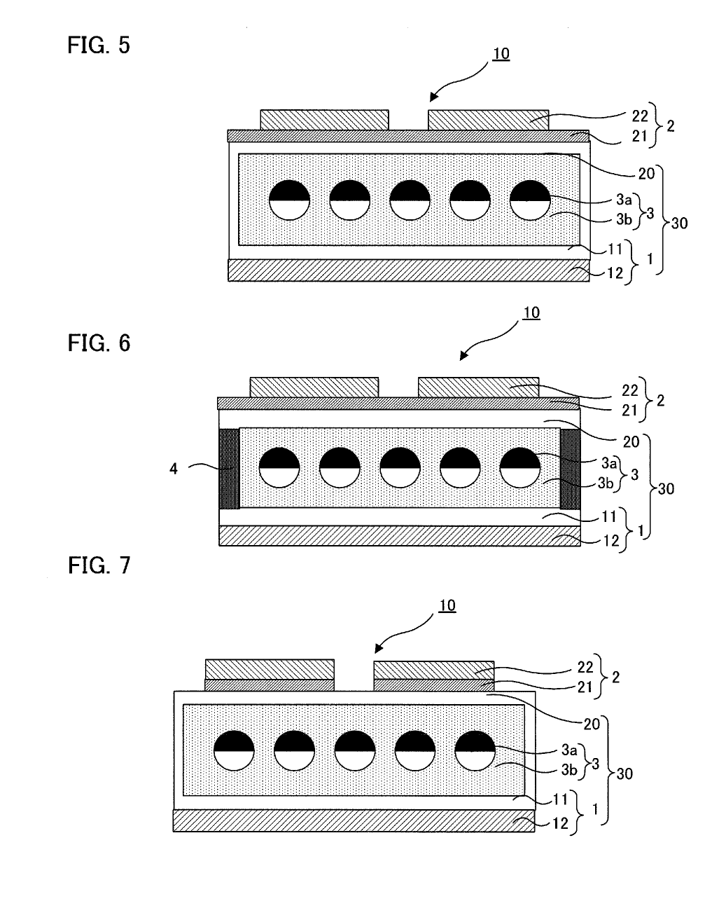

The electronic paper of the present embodiment will be explained with reference to the drawings. FIG. 5 is a schematic cross-sectional view showing an example of the electronic paper of the present embodiment. As shown in FIG. 5, the electronic paper 10 of the present embodiment comprises: a twist ball member 30 further comprising: a transparent electrode side base material 1 having a first base material 11 comprising a film having transparency and a transparent electrode 12 formed on one side surface of the first base material 11, a film-like supporting base material 20 with an insulation property, and a twist ball layer 3 comprising a twist ball 3a and a low polarity solvent layer 3b including a low polarity solvent, in which the twist ball layer 3 is sealed with the first base material 11 and the supporting base material 20; and a counter electrode side base material 2 having a second base material 21 including a film with an insulation property, and a counter electrode 22 formed on one side surface of the second base material 21, characterized in that the counter electrode side base material 2 is disposed on the outer side of the supporting base material 20 of the twist ball member 30 in such a way that the counter electrode 22 is on the opposite side with respect to the twist ball member 30. Although an example of sealing the twist ball member 30 by the lamination process of the first base material 11 and the supporting base material 20 is shown in FIG. 5 in a simplified way, the twist ball member 30 may be sealed by disposing a sealing agent 4 between the first base material 11 and the supporting base material 20 as shown in FIG. 6. Since the numerals not explained in FIG. 6 are same as those explained in FIG. 5, they are not mentioned here.

Although it is not shown in the drawings, the electronic paper of the present embodiment may be a passive driving type electronic paper. In this case, the counter electrode formed on the counter electrode side base material and the transparent electrode formed on the transparent electrode side base material have a corresponding pattern.

Also in the present embodiment, as it was explained in “1. Electronic paper of a first embodiment”, since the counter electrode has a configuration not contacted directly with the twist ball layer, image display deterioration of the electronic paper by elution of the counter electrode material into the low polarity solvent of the twist ball layer can be prevented. Moreover, yield decline at the time of attaching due to ruggedness of the counter electrode or deterioration of the image display of the electronic paper can be prevented.

Furthermore, in the case the electronic paper of the present embodiment is an electronic paper for a segment, since the counter electrode side base material is disposed on the outer side of the supporting base material of the twist ball member in such a way that the counter electrode is disposed on the opposite side with respect to the twist ball layer, the wiring can easily be taken out from the counter electrode. Moreover, in the present embodiment, since the counter electrode side base material has a configuration disposed on the supporting base material, new image display can be enabled only by replacing the counter electrode side base material so that reuse of the electronic paper can be facilitated.

Here, as the method for carrying out the image display using the electronic paper of the present embodiment, in the same manner as explained in for example “1. Electronic paper of a first embodiment”, it can be carried out by applying a predetermined electric field E between the transparent electrode and the counter electrode for having the twist ball interposed between the transparent electrode and the counter electrode under the electric field for rotating the twist ball in the twist ball layer of the twist ball member. Here, in the present embodiment, although the second base material and the twist ball layer are disposed via the supporting base material, also in this case, a desired image display can be carried out by rotating the twist ball by the predetermined electric field E generated between the transparent electrode and the counter electrode.

Hereafter, each configuration used in the electronic paper of the present embodiment will be explained.

### (1) Twist Ball Member

The twist ball member used in the present embodiment includes: a transparent electrode side base material having a first base material comprising a film having transparency and a transparent electrode formed on one side surface of the first base material, a film-like supporting base material with an insulation property, and a twist ball layer including a twist ball and a low polarity solvent layer including a low polarity solvent, in which the twist ball layer is sealed with the first base material and the supporting base material.

Here, since the above-mentioned transparent electrode side base material is same as that explained in “1. Electronic paper of a first embodiment”, it is not mentioned here.

### (a) Supporting Base Material

The supporting base material used in this embodiment is a film-like member having an insulation property for sealing the twist all layer together with the first base material used for the transparent electrode side base material for providing a twist ball member. Moreover, the supporting base material has the counter electrode side base material disposed on the opposite side with respect to the twist ball layer.

Such a supporting base material is not particularly limited as long as it can seal the twist ball layer together with the first base material used for the transparent electrode side base material for providing a twist ball member, and the counter electrode side base material can be disposed on the surface on the opposite side with respect to the twist ball layer of the supporting base material so that it may either be transparent or not transparent.

As the material for the supporting base material, the same materials for the first base material and the second base material mentioned in “1. Electronic paper of a first embodiment” can be optionally selected and used. Moreover, the material for the supporting base material is preferably a material enabling lamination process. Since the material enabling lamination process is used for the material for the first base material and the supporting base material, the twist ball layer can be sealed by the lamination process. Moreover, in the case a material enabling the lamination process is used for the material of the first base material and the supporting base material, it is preferable that the materials for the first base material and the supporting base material are same. Since the materials of the first base material and the supporting base material are same, adhesion at the time of the lamination process of the first base material and the supporting base material can be made higher.

The film thickness of the supporting base material is not particularly limited as long as the twist ball member is provided by sealing the twist ball layer together with the first base material, and the counter electrode side base material can be disposed on the surface on the opposite side with respect to the twist ball layer of the supporting base material. Specifically, it is preferably in a range of 10 μm to 300 μm, more preferably in a range of 15 μm to 100 μm, and particularly preferably in a range of 25 μm to 50 μm. In the case the film thickness of the supporting base material is less than the above-mentioned range, the counter electrode side base material can hardly be disposed on the supporting base material. In the case the film thickness of the supporting base material is more than the above-mentioned range, a preferable image display can hardly be carried out in the electronic paper of the present embodiment.

### (b) Twist Ball Layer

The twist ball layer used in the present embodiment includes a twist ball and a low polarity solvent, and it is sealed with the first base material and the supporting base material of the transparent electrode side base material.

The sealing method for the twist ball layer is not particularly limited as long as it comprises the twist ball and the low polarity solvent layer including the low polarity solvent so as to be sealed with the first base material and the supporting base material. The twist ball layer sealing method may be for example, a method of sealing the twist ball layer by disposing a sealing agent for sealing between the first base material used for the transparent electrode side base material and supporting base material, or a method of sealing the twist ball layer by using a material enabling lamination process for the first base material used for the transparent electrode side base material and the supporting base material, and executing the lamination process of the first base material and the supporting base material. In the present embodiment, a method of sealing the twist ball layer by the lamination process is more preferable. Since the reason why the method of the lamination process is preferable is same as that explained in “1. Manufacturing method for an electronic paper of a first embodiment”, it is not mentioned here.

Moreover, since the configuration of the twist ball layer is same as that explained in “1. Electronic paper of a first embodiment”, it is not mentioned here.

### (2) Counter Electrode Side Base Material

The counter electrode side base material used in the present embodiment has a second base material and a counter electrode with the counter electrode disposed on the opposite side with respect to the above-mentioned twist ball member on the outer side of the supporting base material of the twist ball member.

The second base material used for the counter electrode side base material in the present embodiment is not particularly limited as long as the counter electrode can be formed on the second base material and the counter electrode side base material can be disposed on the outer side of the supporting base material of the twist ball member in such a way that the counter electrode is on the opposite side with respect to the twist ball member. For example, as shown in FIG. 5, it may be a base material capable of covering the entire surface of the supporting base material 20, or as shown in FIG. 7, it may be a base material having a pattern corresponding to the counter electrode 22 formed on the second base material 21. Since the numerals not explained in FIG. 7 are same as those in FIG. 5, they are not mentioned here.

Since the second base material used in the counter electrode side base material is same as that explained in “1. Electronic paper of a first embodiment” except for the above-mentioned points, it is not mentioned here. Moreover, since the above-mentioned counter electrode is also same as that explained in “1. Electronic paper of a first embodiment”, it is not mentioned here.

The arrangement method for the counter electrode side base material used in the present embodiment is not particularly limited as long as it is disposed on the outer side of the supporting base material of the twist ball member and the counter electrode is on the opposite side with respect to the twist ball member. The counter electrode side base material and the supporting base material may be disposed by a method of completely fixing via an adhesive, and the like, or the counter electrode and the supporting base material may be disposed by an easily detachable method. In the present embodiment, it is preferable that the counter electrode side base material and the supporting base material are disposed by an easily detachable method. As the method of disposing the counter electrode side base material, specifically, a disposing method of providing a fixing part for fixing the counter electrode side base material on the supporting base material for fixing the counter electrode side base material onto the fixing part, a disposing method of installing the counter electrode side base material and the supporting base material via a re-detachable adhesive, and the like can be presented.

In this step, in particular, a method of installing the counter electrode side base material and the supporting base material via a re-detachable adhesive is preferable. Since the electronic paper of the present embodiment enables reuse of the electronic paper by replacing the counter electrode side base material and the counter electrode side base material and the supporting base material are disposed via a re-detachable adhesive, the counter electrode side base material can easily be replaced.

Here, “re-detachable” denotes that the supporting base material and the second base material can be removed without breakage in the case of detaching the supporting base material and the second base material after adhesion. As such an adhesive, an acrylic-based bonding agent or adhesive, a silicone-based bonding agent or adhesive, a natural rubber-based bonding agent or adhesive, an ethylene-vinyl chloride (EVA)-based bonding agent or adhesive, and a urethane-based bonding agent or adhesive can be presented. Moreover, it is preferable that the above-mentioned re-detachable adhesive is applied on the counter electrode side base material. Since the above-mentioned re-detachable adhesive does not remain on the supporting base material surface, reuse of the twist ball member can be facilitated.

The clearance between the supporting base material and counter electrode side base material at the time of disposing the counter electrode side base material on the supporting base material used in the present embodiment is not particularly limited as long as a clearance enabling a desired image display by rotating the twist ball is provided at the time of image display using the electronic paper of the present embodiment so that it is preferably 50 μm or less, more preferably 30 μm or less, and particularly preferably 20 μm or less. In the case it is more than the above-mentioned range, supply of the voltage applied to the transparent electrode and the counter electrode for obtaining an electric field E necessary for rotating the twist ball is substantially difficult.

### (3) Other Members

The electronic paper of the present embodiment is not particularly limited as long as it comprises the above-mentioned twist ball member, and the counter electrode side base material so that members needed can be added optionally. As such a member, a sealing agent used for sealing the above-mentioned twist ball member can be presented. Since such a sealing agent may be same as a common sealing agent used at the time of attaching and sealing base materials, it is not mentioned here.

### (4) Application

Since the application of the electronic paper of the present embodiment is same as those explained in “1. Electronic paper of a first embodiment”, it is not mentioned here.

The present embodiment is used further preferably for a segment application such as a poster and an advertisement in a train.

The present invention is not limited to the above-mentioned embodiments. The above-mentioned embodiments are only examples, and any one having a configuration substantially same as the technological idea mentioned in the scope of the claims of the present invention for achieving the same effects are incorporated in the technological scope of the present invention.

### EXAMPLES

### Example 1

A twist ball of about a 100 μm average particle size having a black phase charged positively and a white phase charged negatively was prepared. A sheet of a 300 μm thickness with the twist ball dispersed was produced by dispersing the same in a thermosetting silicone resin, applying the same onto a glass with a coater, and applying a heat treatment. Then, the above-mentioned sheet was impregnated with a silicone oil for 24 hours so as to be swelled for obtaining a twist ball layer.

Then, a laminate film with an ITO film formed on a PET surface (CPP/PET) was prepared (transparent electrode side base material).

Then, a laminate film with an aluminum film (counter electrode) formed on the PET surface according to the display design (CPP/PET) was prepared (counter electrode side base material).

Then, with the CPP surface of the transparent electrode side base material and the CPP surface of the counter electrode side base material facing with each other, the twist ball layer was interposed therebetween for carrying out lamination. Thereafter, wiring was applied using a conductive tape and a lead line according to the display design.

### Example 2

A twist ball of about a 100 μm average particle size of a colored phase produced by blending a blue coloring agent and a black coloring agent charged positively and a white phase charged negatively was prepared. A sheet of a 300 μm film thickness with the twist ball dispersed was produced by dispersing the same in a thermosetting silicone resin, applying the same onto a glass with a coater, and applying a heat treatment. Then, the above-mentioned sheet was impregnated with a silicone oil for 24 hours so as to be swelled for obtaining a twist ball layer.

Then, two laminate films (CPP/PET) were prepared for carrying out lamination with the CPP surface disposed on the twist ball layer side.

Then, a PET film with an ITO film formed (transparent electrode side base material) was prepared. Moreover, a PET film with an aluminum film formed according to the display pattern (counter electrode side base material) was prepared.

Then, a bonding agent was applied on the side without formation of the ITO film of the transparent electrode side base material and the surface on the side without formation of the aluminum film of the counter electrode side base material so as to be attached on the laminate film of the twist ball layer. Thereafter, wiring was applied using a conductive tape and a lead line according to the display design of the counter electrode side base material.

By use of the electronic papers of the Example 1 and the Example 2, preferable image display was enabled.

### REFERENCE SIGNS LIST

1 transparent electrode side base material
11 first base material
12 transparent electrode
2 counter electrode side base material
21 second base material
22 counter electrode
3 twist ball layer
3a twist ball
3b low polarity solvent layer
10 sealing agent
20 electronic paper
20 supporting base material
30 twist ball member

1.-5. (canceled)

6. A twist ball type electronic paper comprising:
a transparent electrode side base material having a first base material comprising a film having transparency, and a transparent electrode formed on one side surface of the first base material;
a counter electrode side base material having a second base material comprising a film with an insulation property, and a counter electrode formed on one side surface of the second base material; and
a twist ball layer comprising a twist ball and a low polarity solvent layer including a low polarity solvent,
wherein the twist ball layer is sealed with the first base material and the second base material, and
wherein the counter electrode side base material is disposed in such a way that the counter electrode is disposed on an opposite side with respect to the twist ball layer.

7. The twist ball type electronic paper according to claim 6, wherein the first base material and the second base material are made of a material enabling a lamination process so that the twist ball layer is sealed by a lamination process of the first base material and the second base material.

8. A twist ball type electronic paper comprising:
a twist ball member including:
a transparent electrode side base material having a first base material comprising a film having transparency and a transparent electrode formed on one side surface of the first base material, and
a film-like supporting base material with an insulation property, and
a twist ball layer including a twist ball and a low polarity solvent layer including a low polarity solvent, in which the twist ball layer is sealed with the first base material and the supporting base material, and
a counter electrode side base material having a second base material comprising a film with an insulation property, and a counter electrode formed on one side surface of the second base material,
wherein the counter electrode side base material is disposed on an outer side of the supporting base material of the twist ball member in such a way that the counter electrode is on an opposite side with respect to the twist ball member.

9. The twist ball type electronic paper according to claim 8, wherein the counter electrode side base material is disposed on a surface on the opposite side with respect to the twist ball member of the supporting base material via a re-detachable adhesive.

10. The twist ball type electronic paper according to claim 8, wherein the first base material and the supporting base material are made of a material enabling a lamination process so that the twist ball layer is sealed by a lamination process of the first base material and the supporting base material.
